(19) United States
(12) Patent Application Publication
(10) Pub. No.: US 2025/0026458 A1
(43) Pub. Date: Jan. 23, 2025

(54) METHOD FOR ASSISTING WITH GUIDING A SURFACE VESSEL FOR TOWING AN UNDERWATER DEVICE BY MEANS OF A CABLE

(71) Applicant: THALES, MEUDON (FR)

(72) Inventors: Quentin DUPUIS, BREST (FR); Christophe BOREL, BREST (FR)

(21) Appl. No.: 18/716,705

(22) PCT Filed: Dec. 12, 2022
(86) PCT No.: PCT/EP2022/085308

§ 371 Date: Jun. 5, 2024

(30) Foreign Application Priority Data
Dec. 21, 2021 (FR) FR2114115

(51) Int. Cl. B63B 49/00; B63B 21/66; B63G 8/00; B63G 8/39

(52) U.S. Cl. CPC B63B 49/00; B63B 21/66; B63G 8/001; B63G 8/39; B63G 2008/002

(57) ABSTRACT

A method for assisting the guidance of a surface vessel intended to tow an underwater device, the method includes a) discretizing the geographical sector around the surface vessel into a plurality of zones, with each zone being classified according to a degree of accessibility from among a set of degrees of accessibility; b) computing a set of candidate trajectories of the surface vessel in the geographical sector, with each candidate trajectory corresponding to a different gyration rate from the current position of the surface vessel; c) classifying each candidate trajectory as a function of the degree of accessibility of the zone of the geographical sector traversed by the possible trajectory, and as a function of the feasibility of one or more predefined actions on the candidate trajectory; d) generating a display of the zones and of the candidate trajectories on a human-machine interface, as a function of their classification and/or a transmission of instructions relating to the actions.

### CROSS-REFERENCE TO RELATED APPLICATIONS

This application is a National Stage of International patent application PCT/EP2022/085308, filed on Dec. 12, 2022, which claims priority to foreign French patent application No. FR 2114115, filed on Dec. 21, 2021, the disclosures of which are incorporated by reference in their entireties.

### FIELD OF THE INVENTION

The invention generally relates to the field of surface vessel guidance, and in particular to a surface vessel towing an immersed body, or underwater device, via a cable.

### BACKGROUND

The underwater device can typically comprise a variable immersion sonar, intended to carry out underwater detection measurements, or even any other appliance operating under water.

When a surface vessel, such as a ship, tows an underwater device at a certain speed, said device tends to rise toward the surface. A case such as this particularly occurs when the tow cable is not faired. The cable then can be much longer than the immersion depth of the underwater device and the water depth.

In such a case, the exact depth of the underwater device cannot be determined with certainty. The tow cable can adopt a profile in the form of an “elongated S”, but numerous other profiles are possible.

In general, during gyration operating conditions, the underwater device tends to descend and approach the bottom, which represents a danger to the underwater device. At high speed, the underwater device begins by losing altitude, before rising slightly.

Consequently, in order to reach a certain immersion depth, a significant margin always needs to be provided when unwinding the tow cable.

However, it is essential that the underwater device does not collide with the bottom, which would risk damaging said device.

At present, known solutions are used that are based on charts but they require the provision of numerous margins. These charts indicate the depth of the underwater device as a function of the length of unwound cable, for various speeds of the surface vessel.

Such an approach offers minimal flexibility and is relatively difficult to implement, which can induce risks if the navigation parameters change rapidly.

Moreover, applying numerous margins prevents the navigation of the surface vessel with the towed craft in zones that nevertheless do not exhibit any risks of collision with the bottom.

Another known solution, which is described in document JP2005193767A, proposes a device for controlling the depth of an underwater device, which computes the value of an upper altitude limit function, and the value of a lower altitude limit function, which are obtained by adding margins to the topographical data.

A potential intersection with an obstacle is computed using the value of the upper altitude limit function, and the value of the lower altitude limit function, and the depth of the underwater device is corrected in the event of the detection of a potential intersection.

However, such a device uses a database of characteristics in response to the underwater device, which corresponds to the aforementioned charts, and which therefore is not very flexible.

Thus, a requirement exists for improved guidance assistance methods and systems.

### SUMMARY OF THE INVENTION

The invention aims to overcome the aforementioned disadvantages by proposing a method that is flexible and simple to use.

Therefore, an aim of the invention is a method for assisting the guidance of a surface vessel intended to tow an underwater device by means of a tow cable, the method comprising:
a) discretizing the geographical sector around the surface vessel into a plurality of zones, with each zone being classified according to a degree of accessibility from among a set of degrees of accessibility, as a function of the bathymetry of the geographical sector and of current navigation parameters of the surface vessel comprising the length of the tow cable;
b) computing a set of candidate trajectories of the surface vessel in said geographical sector, with each candidate trajectory corresponding to a different gyration rate from the current position of the surface vessel;
c) classifying each candidate trajectory as a function of the degree of accessibility of the zone of the geographical sector traversed by the possible trajectory, and as a function of the feasibility of one or more predefined actions on said candidate trajectory;
d) generating a display of the zones and of the candidate trajectories on a human-machine interface, as a function of their classification and/or a transmission of instructions relating to said actions.

Advantageously, each zone has a marginal minimum depth, with said marginal minimum depth of each zone being computed based on the minimum depth of all the zones located within a predefined radius around said zone, and the underwater device has a current depth and wherein the set of degrees of accessibility comprises:
a first degree of accessibility if the marginal minimum depth of the zone is greater than or equal to the sum between a vertical protective margin of the underwater device and the current depth of the underwater device, with said current depth of the underwater device being computed as a function of the reeled-out length of the tow cable and of the speed of the surface vessel;
a second degree of accessibility if the marginal minimum depth of the zone is strictly less than said sum between the vertical protective margin of the underwater device and the current depth of the underwater device, and if the marginal minimum depth of the zone is greater than or equal to the protective margin of the underwater device;
a third degree of accessibility if the marginal minimum depth of the zone is strictly less than the vertical protective margin of the underwater device.

Advantageously, a first zone appearance parameter, a second zone appearance parameter, and a third zone appearance parameter are respectively assigned to the first degree of accessibility, to the second degree of accessibility, and to the third degree of accessibility.

Advantageously, the first zone appearance parameter, the second zone appearance parameter, and the third zone appearance parameter correspond to different colors.

Advantageously, each candidate trajectory is sampled at a plurality of equidistant points, and wherein the following is assigned to each point, from the first point of the candidate trajectory:
a first trajectory appearance parameter if said first trajectory appearance parameter has been assigned to the previous point and if the estimated depth of the underwater device is less than the sum of the marginal minimum depth of the zone and of the vertical protective margin of the underwater device, with the estimated depth of the underwater device being computed as a function of the reeled-out length of the tow cable, of the speed of the surface vessel and of the gyration rate corresponding to the candidate trajectory on which the point is located;
a second trajectory appearance parameter if the corrected estimated depth of the underwater device is less than the sum of the marginal minimum depth and of the vertical protective margin of the underwater device, with the corrected estimated depth of the underwater device being computed as a function of the reeled-out length of the tow cable, of the speed of the surface vessel, of the gyration rate corresponding to the candidate trajectory on which the point is located, and of one or more predefined actions on said candidate trajectory, with the second trajectory appearance parameter also being assigned to the following points of the candidate trajectory;
a third trajectory appearance parameter if the gyration of the candidate trajectory is impossible taking into account the length of the tow cable, or if the gyration is impossible taking into account the speed of the surface vessel, with the third trajectory appearance parameter also being assigned to the following points of the candidate trajectory.

Advantageously, the first trajectory appearance parameter, the second trajectory appearance parameter, and the third trajectory appearance parameter correspond to different colors.

Advantageously, the method further comprises a step of correcting the vertical protective margin of the underwater device, and/or a step of correcting the predefined radius used when computing the marginal minimum depth.

Advantageously, said predefined actions include an action of raising the underwater device and/or an action of accelerating the surface vessel.

Advantageously, the feasibility of one or more predefined actions on said candidate trajectory is computed taking into account the time for carrying out the action prior to the arrival of the surface vessel in a zone classified according to a degree of accessibility different from the zone corresponding to the current position of the surface vessel.

Advantageously, the step of generating a display of each possible trajectory comprises generating a display of the trajectory in the form of an arc of a circle passing through a point representing the surface vessel, or in the form of a segment aligned with the point representing the heading of the surface vessel.

Advantageously, steps a) to d) are repeated periodically.

Advantageously, the method comprises, in response to the user selecting one of the points located on the representation of one of the candidate trajectories generated on the human-machine interface, a step of simulating steps a) to d), while considering that the surface vessel is fictitiously positioned at said point.

The invention also relates to a computer program product, comprising instructions for executing the predefined method when the program is executed by a processor.

The invention also relates to a system for assisting the guidance of a surface vessel intended to tow an underwater device by means of a tow cable, the system comprising:
a computation device comprising:
a discretization unit, configured to discretize the geographical sector around the surface vessel into a plurality of zones, with each zone being classified according to a degree of accessibility from among a set of degrees of accessibility, as a function of current navigation parameters of the surface vessel comprising the length of the tow cable;
a first computation unit, configured to compute a set of candidate trajectories of the surface vessel in said geographical sector, with each candidate trajectory corresponding to a different gyration rate from the current position of the surface vessel;
a classification unit, configured to classify each candidate trajectory as a function of the degree of accessibility of the zone of the geographical sector traversed by the possible trajectory, and as a function of the feasibility of one or more predefined actions on said candidate trajectory;
a human-machine interface configured to generate a display of the zones and of the candidate trajectories as a function of their classification and/or to transmit the instructions relating to said actions.

Advantageously, the underwater device comprises a sonar.

### BRIEF DESCRIPTION OF THE DRAWINGS

Further features, details and advantages of the invention will become apparent upon reading the description provided with reference to the appended drawings, which are given by way of example.

FIG. 1 illustrates a surface vessel towing an underwater device.

FIG. 2 illustrates a flowchart representing the guidance assistance method of the invention.

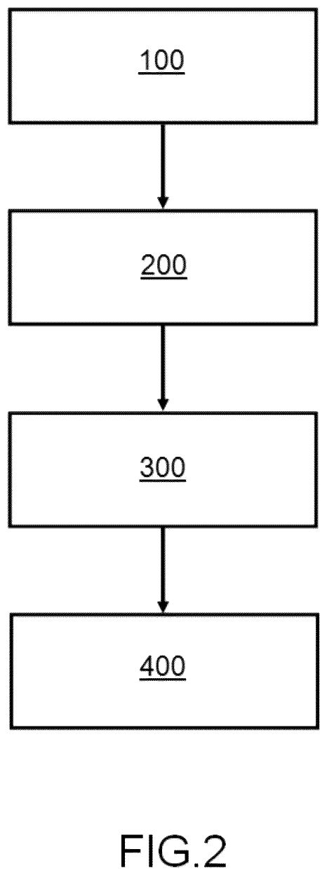

FIG. 3 illustrates a step of discretizing the geographical sector around the surface vessel into a plurality of zones.

FIG. 4 is a diagram representing an example of the display of the zones and of the possible trajectories on a human-machine interface.

FIG. 5 illustrates a step of computing a set of candidate trajectories, as well as a step of classifying the various possible trajectories.

FIG. 6 is a diagram of a computer architecture implementing the method, according to embodiments of the invention.

### DETAILED DESCRIPTION

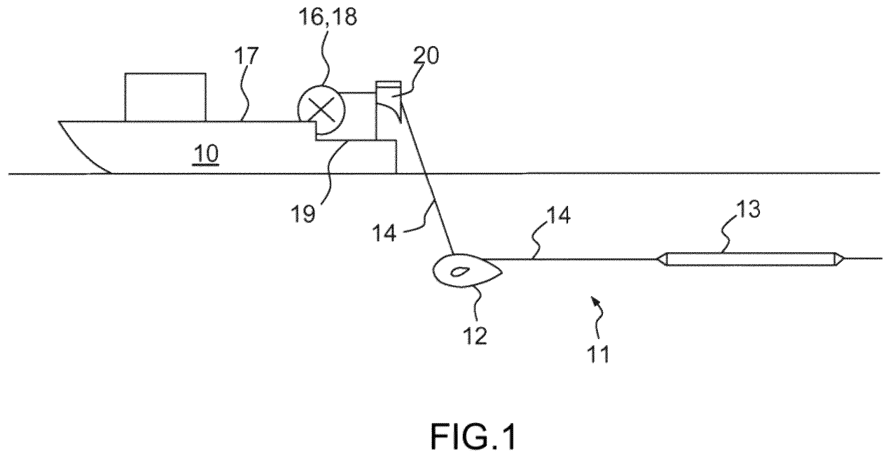

FIG. 1 shows an example of a surface vessel 10 towing an underwater device 11.

In embodiments, the underwater device 11 is an active sonar comprising an acoustic emission antenna 12, also called “fish”, and an acoustic reception antenna 13, also called “streamer”.

The surface vessel 10 comprises at least one tow cable 14 configured to tow the two antennas 12 and 13. The tow cable 14 also routes signals and power supplies between the surface vessel 10 and the antennas 12 and 13 of the sonar.

In one of the embodiments, the surface vessel 10 can comprise two separate tow cables directly connected to the surface vessel 10 (mode called independent mode). In another mode, called dependent mode, the first cable, which is connected to the surface vessel 10, is configured to tow the fish 12, and the second cable is configured to tow the streamer 13, with the second cable towing the streamer then being fixed to the fish 12.

In order to better understand the invention, the following description of embodiments of the invention will be provided mainly with reference to a single tow cable 14, by way of non-limiting example. The method can be generalized to a surface vessel 10 comprising a plurality of tow cables.

The antennas 12 and 13 can be mechanically secured and electrically and/or optically connected to the tow cable 14 in an appropriate manner. The reception antenna 13 is formed by a tubular shaped linear antenna (hence the name “streamer”), while the transmission antenna 12 is integrated into a volumetric structure assuming a shape similar to that of a fish (hence the name “fish”).

The reception streamer 13 can be arranged at the rear, at the end of the cable 14, while the fish 12 is positioned on the portion of the cable 14 closest to the surface vessel 10.

The underwater device 11 can be used to carry out underwater acoustic missions.

During an underwater acoustic mission, the antenna 12 is configured to emit sound waves in the water and the reception antenna 13 is configured to pick up any echoes originating from targets on which the sound waves originating from the antenna 12 reflect.

Launching and retrieving the underwater device 11 into and out of the water can be carried out by means of a winch 16 arranged on a deck 17 of the surface vessel 10. The winch 16 can comprise a reel 18 dimensioned for winding the cable 14 as well as the reception antenna 13.

The winch 16 can also comprise a frame intended to be fixed to the deck of the ship. The reel 18 is able to pivot relative to the chassis in order to allow the cable to be wound. Winding the cable 14 allows the fish 12 to be hauled on board the surface vessel 10, for example, onto a rear platform 19 provided for this purpose.

The underwater device can comprise a fairlead 20 configured to guide the cable 14 downstream of the reel 18. The fairlead 20 forms the last guide element of the cable 14 before it descends into the water.

The embodiments of the invention provide a method for assisting the guidance of the surface vessel 10 intended to tow the underwater device 11 by means of the tow cable 14.

The guidance assistance method according to the embodiments of the invention can be implemented in a device located in the surface vessel 10, or in a simulator.

FIG. 1 is a flowchart representing the guidance assistance method according to embodiments of the invention.

In step 100, the geographical sector around the surface vessel is divided into a plurality of zones, with each zone being characterized by position data. The geographical sector around the surface vessel corresponds, according to some embodiments, to a circle with a predefined radius, centered on the surface vessel 10.

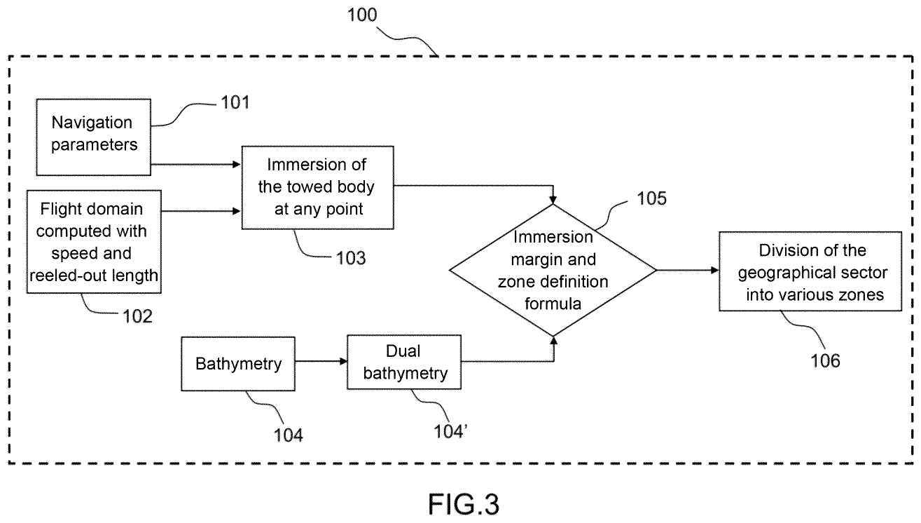

In one embodiment, illustrated in FIG. 3, step 100 involves previously determining navigation parameters relating to the surface vessel, for example, by means of measurements (101). The navigation parameters can comprise:
a first parameter representing the current speed of the surface vessel 10 (actual speed) determined at a current instant. The current speed of the surface vessel 10 can be measured, for example, using a speed indicator, or by means of a navigation device on board the surface vessel 10;
the reeled-out (i.e., unwound) length at the current instant. In one embodiment, the winch 16 can be equipped with a measurement instrument configured to determine the reeled-out length, for example, by determining the angle of rotation of the winch 16.

The function that links the navigation parameters and the estimated immersion depth is called the “flight domain”. The “flight domain” function is stored by a processing unit, during step 102.

In step 103, the current depth of the underwater device 11, at any point of the geographical sector, is computed based on the navigation parameters and the function indicating the flight domain.

In one embodiment, the computation 103 can be implemented using a computer on board the surface vessel 10, for example, in the form of a client application in the onboard computer of the surface vessel 10.

In embodiments, the computation step 103 can also take into account parameters relating to the behavior of the underwater device 11, in its flight domain, such as, for example:
a parameter indicating whether the underwater device 11 has positive or negative buoyancy;
a parameter indicating whether the underwater device 11 is ascending or descending; and/or
a parameter indicating whether or not the underwater device 11 has variable fins that can be commanded or controlled according to the traction force.

Furthermore, the computation step 103 can use bathymetry data 104, namely topographical readings relating to the underwater reliefs, which constitute a map of a digital model of the terrain of the geographical sector around the surface vessel 10.

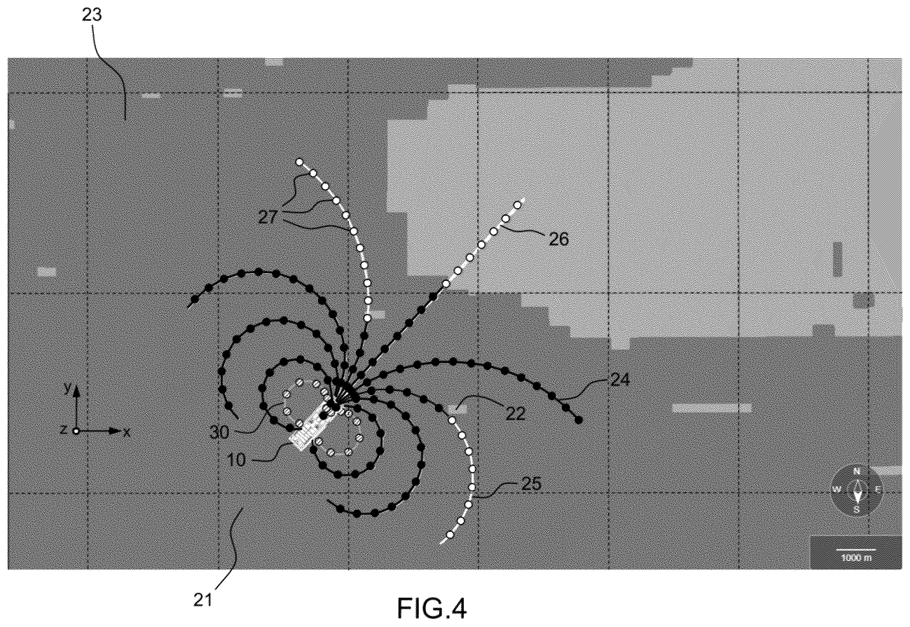

In step 100, the geographical sector is discretized into a plurality of zones, the size of which can be adjustable. Each zone (22, 23 in FIG. 4) can be represented by a predefined number of pixels, forming a given and constant shape from one zone to the next, such as a square, for example.

The zones are dimensioned so that the relevant information is visible to the user with the naked eye, while providing a sufficiently refined cut-out of the geographical sector.

The discretization of the geographical sector thus provides a mosaic of zones, the position of which is determined by coordinates (x, y) in the reference frame of FIG. 4. For each of the zones, it is possible to determine the most unfavorable waypoint for the underwater device 11, namely the minimum depth of the zone.

As used herein, the “minimum depth” refers, for a given zone, to the depth of the highest point of the zone, by absolute altitude (along the z-axis, FIG. 4). The minimum depth for each zone of the geographical sector can be computed and stored in a memory in step 104.

According to an advantageous embodiment, a marginal minimum depth can be computed for each zone, based on the minimum depth of all the zones located within a predefined radius around said zone (step 104′). The computation of the marginal minimum depth thus allows any “horizontal” uncertainties to be taken into account, i.e., uncertainties linked to the position of the surface vessel 10 and/or of the underwater device 11.

For example, for a predefined radius equal to a nautical mile, for each point (or zone) of the map, a disk with a radius equal to a nautical mile is centered on the point, then the point that has the minimum depth in the disk is determined.

This minimum depth in the vicinity of any point allows a “dual” bathymetry to be constructed, i.e., a bathymetry that includes an additional horizontal margin. The predefined radius can have a default value, and/or can be adjusted by the user.

The computation of the dual bathymetry, which can consume a considerable amount of computing resources, can be carried out before the mission.

In step 105, the vertical immersion margin of the underwater device 11 is extracted from a memory. The vertical (or protective) immersion margin of the underwater device 11 corresponds to a vertical protective margin of the underwater device 11. The vertical protective margin can assume a default value, which is provided, for example, by the manufacturer of the underwater device 11, and can be subsequently corrected.

The protective margin means that it is possible to take into account any slight movements of the underwater device 11 that are difficult to control, when it is immersed, which can themselves partly depend on the structural features of the underwater device 11, as well as on marine currents.

In step 106, each zone of the entire geographical sector can be classified as a function of a degree of accessibility associated with the zone and representing the level of accessibility of the zone. All the bathymetry 104 of the entire geographical sector can be taken into account in order to determine the level of accessibility of the surface vessel 10 towing the underwater device 11, and not only a few isobaths.

FIG. 4 illustrates an example of the classification of the zones according to their degree of accessibility. In embodiments, a zone appearance parameter can be associated with each zone as a function of its degree of accessibility. The zone appearance parameter can be associated with a given zone, if the zone is accessible by the surface vessel without the underwater device 11, taking into account the current unwinding of the cable, reaching the minimum depth of the zone, taking into account the immersion margins. This is the case, for example, for zone 23 in FIG. 4.

In one embodiment, the first degree of accessibility meets the following condition (1):

$${P}_{min} \geq M + {P}_{c} . \qquad ( 1 )$$

In equation (1), the parameter Pₘ denotes the marginal minimum depth of the zone, the parameter M denotes the vertical protective margin of the underwater device 11, and the parameter P_{c} denotes the current depth of the underwater device 11.

The current depth of the underwater device can be computed as a function of the reeled-out length of the tow cable and of the speed of the surface vessel.

It is possible, for example, to define the parameters of the function that provides the current depth of the underwater device 11 by means of empirical measurements carried out during a calibration phase of the method.

It is possible, for example, to measure the actual depth for different values of the reeled-out length of the tow cable, for different speed values of the surface vessel. In some embodiments, the actual depth can be measured using pressure sensors.

In FIG. 4, it can be seen that some zones with the same degree of accessibility are represented in a contiguous manner, with the classification of the zones being carried out zone-by-zone.

According to one embodiment, a first zone appearance parameter is assigned to the first degree of accessibility. The zone appearance parameter can be, for example, a color parameter, for example, green. The zone with a first degree of accessibility can be green colored, for example.

A second degree of accessibility can be used to characterize the zone if, given the current speed of the surface vessel 10 and the reeled-out length of the tow cable 14, there is a risk of the underwater device 11 colliding with the bottom, while also taking into account the immersion margin. This is the case, for example, for zone 22 in FIG. 4.

In one embodiment, the second degree of accessibility meets the following condition (2):

$${P}_{min} < M + {P}_{c} and {P}_{min} \geq M . \qquad ( 2 )$$

According to one embodiment, a second zone appearance parameter is assigned to the second degree of accessibility. The zone appearance parameter can be, for example, a color parameter, for example, orange. The zone with a second degree of accessibility can be orange colored, for example.

In one embodiment, a third degree of accessibility finally can be used if the minimum depth of the zone is strictly less than the protective margin of the underwater device. This corresponds to the case whereby, irrespective of the reeled-out length of the cable 14, the device 11 will not be able to comply with the immersion margins. This scenario can occur, for example, if a relief is located in an emergent portion of the geographical sector. FIG. 4 does not illustrate this situation.

The following condition (3) thus must be met for the third degree of accessibility:

Pₘᵢₙ<M (3).

According to one embodiment, a third zone appearance parameter is assigned to the third degree of accessibility. The zone appearance parameter can be, for example, a color parameter, for example, red. The zone with a third degree of accessibility can be red colored, for example.

The value of the protective margin can be modified and the impact of this change in value can be viewed in terms of the change in the appearance (color, for example) of some zones on the human-machine interface.

Such a change in values allows the navigation zone to be extended, by releasing the limitation on the protective margin (vertical and/or horizontal) of the underwater device 11.

This mode of viewing by zone and by degree of accessibility provides a good view of the possible evolutions for the surface vessel 10.

In the embodiments where the zone appearance parameters are color parameters, the degrees of accessibility can be distinguished as a function of the color parameters. In one embodiment, the color parameters can be greyscale, for example, black, grey and white.

In other embodiments, the zone appearance parameters can be different patterns for the various degrees of accessibility.

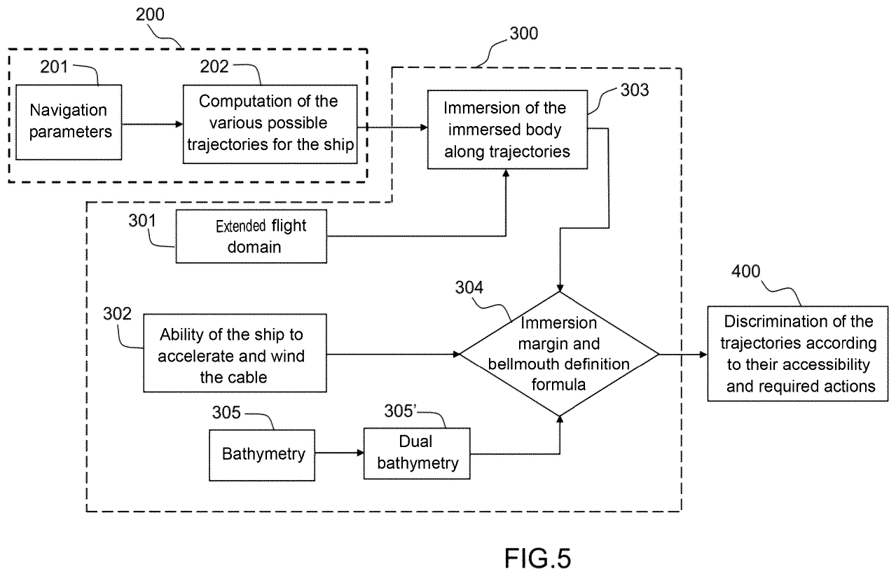

FIG. 5 shows the other steps 200, 300 and 400 for computing the guidance assistance method according to embodiments of the invention.

In the second computation step 200, a set of candidate trajectories (for example, the trajectories 24, 25, 26 of FIG. 4) of the surface vessel 10 in the geographical sector 21 are computed in step 202, as a function of navigation parameters obtained in step 201.

The starting point of each of the candidate trajectories corresponds to the current location of the surface vessel 10 and substantially continues in the form of an arc of a circle, over a predefined length. The value of the chord, for each arc of a circle, is an increasing value. Modelling such trajectories therefore does not involve computational complexity.

Although it is always possible to contemplate that the surface vessel 10 ultimately follows a trajectory that does not exactly correspond to one of the candidate trajectories shown, the sufficiently high number of candidate trajectories shown on the human-machine interface allows a considerable number of navigation options to be provided, as a function of their feasibility.

One of the candidate trajectories corresponds to a segment that starts from the location of the surface vessel 10 and is aligned with its heading.

Each of the candidate trajectories thus corresponds to a different gyration rate of the surface vessel 10. The gyration rate corresponds to the speed at which the surface vessel 10 changes heading, as well as to the direction of its change of heading (port or starboard).

The gyration rate also can be called “gyration speed”. In reality, the gyration rate is the gyration speed of the surface vessel, in degrees per minute (° /min).

It can be computed either based on the variation in heading, or based on the following formula, with a gyration radius extrapolated from the successive positions of the ship (the units are in italics):

$$Gyration rate ( ° / min ) = 360 / Duration\_turn ( min ) = 360 * Speed ( m / min ) / ( 2 * P i * Radius\_gyration ( m ) ) = 360 * 60 * 1852 / ( 2 * P i * 3600 ) * Speed ( knot ) / Radius\_gyration ( m ) = 5556 / P i * Speed ( knot ) / Radius\_gyration ( m )$$

With further reference to FIG. 4, eleven candidate trajectories are shown: one candidate trajectory 26 corresponding to a zero gyration rate, five port trajectories with different gyration rates, and five starboard trajectories with different gyration rates (for example, trajectories 24 and 25 in FIG. 4). Of course, the number of candidate trajectories can be configured in a different manner.

The various candidate trajectories can be determined and then saved in a memory zone.

In a third step 300, each candidate trajectory (24, 25, 26) can be classified as a function of the degree of accessibility of the zone of the geographical sector traversed by the possible trajectory (24, 25, 26), and as a function of the feasibility of one or more predefined actions on said candidate trajectory (24, 25, 26).

The extended gyration domain is computed in a step 301. It corresponds to the flight domain computed during step 102, refined with the additional parameter of the gyration rate of the surface vessel 10.

For each candidate trajectory, the estimated depth of the underwater device 11 can be computed in step 303 as a function of the speed of the surface vessel 10, which is assumed to be constant from the current position of the surface vessel 10, of the reeled-out length of the tow cable, which is also assumed to be constant from the current position of the surface vessel 10, and of the gyration rate on the candidate trajectory.

The reeled-out length of the tow cable corresponds to the length of cable unwound from the winch.

A positive real function f is defined, which as input takes three positive parameters (reeled-out length, speed, gyration radius) and returns the estimated depth of the underwater device 11.

Irrespective of L1, L2, V1, V2, R1 and R2 taken in the physically achievable parameters of the surface vessel 10 (limited by the length of cable, the maximum speed of the surface vessel 10 and its minimum gyration radius):
if L1=0 then f(L1, V1, R1)=0;
if V1=0 then f(L1, V1, R1)=L1;
if L1<L2 then f(L1, V1, R1)<f (L2, V1, R1);
if V1<V2 then f(L1, V1, R1)>f (L1, V2, R1);
if R1<R2 then f(L1, V1, R1)>f (L1, V1, R2).

It is possible, for example, to define the parameters of the function that provides the estimated depth of the underwater device 11 by means of empirical measurements performed during a calibration phase of the method.

It is possible, for example, to measure the actual depth for different speed values of the surface vessel 10, for different unwound lengths of the tow cable, and for different gyration rates. In some embodiments, the actual depth can be measured using pressure sensors.

Other parameters also can be taken into account, such as the one or more behavior parameters of the underwater device 11 in its flight domain, indicating whether the device has positive or negative buoyancy, if it is ascending or descending, or even whether or not it has variable fins that can be commanded or controlled according to the traction force.

The depth of the underwater device 11 thus can be computed at any point of the candidate trajectory.

The classification of each candidate trajectory also can be established as a function of the feasibility of one or more predefined actions on each of the candidate trajectories (302). The predefined actions are mechanical actions or maneuvers that can be carried out in order to raise the underwater device 11 toward the water surface. In one embodiment, the actions can comprise:
a potential acceleration of the surface vessel 10, from its current position, before reaching a point that corresponds to the transition from a zone with a first degree of accessibility to a zone with a second degree of accessibility; and/or
an action involving taking up a length of tow cable 14 (winding action) before reaching a point that corresponds to the transition from a zone with a first degree of accessibility to a zone with a second degree of accessibility.

These two actions can be undertaken simultaneously, i.e., by simultaneously accelerating the surface vessel 10 and winding the tow cable 14, or successively.

Based on the bathymetry data (block 305) and the dual bathymetry data (block 305′), on the feasibility of one or more predefined actions, and on the estimated depth on the candidate trajectory, in step 304, the vertical and horizontal immersion (or protective) margins are computed, and each of the candidate trajectories according to either one of the appearance features can be classified.

In a preferred embodiment, the feasibility of one or more predefined actions on the candidate trajectory can be computed by taking into account the time taken to carry out the action (duration taken to carry out the action) before the surface vessel 10 reaches a zone classified according to a degree of accessibility different from the zone corresponding to the current position of the surface vessel 10.

Thus, if the candidate trajectory enters a zone with a first degree of accessibility and then enters a zone with a second degree of accessibility, corrective actions can be carried out before the surface vessel transitions from the zone with a first degree of accessibility to the zone with a second degree of accessibility.

In a fourth step 400, a display of the zones (22, 23) and of the candidate trajectories (24, 25, 26) is generated on a human-machine interface, as a function of the classification of the trajectories. The method can further comprise a step of transmitting instructions relating to the predefined actions (for example, raising of the underwater device 11, acceleration of the surface vessel 10).

The display of the candidate trajectories and the transmission of the instructions can be simultaneously generated on the same screen of the human-machine interface. For example, in response to an operator (for example, an operator responsible for navigating) pointing to a candidate trajectory using a cursor, a display of instructions can appear in a window, and can disappear when the cursor is no longer positioned on the trajectory (“pop-up” type display, or contextual window).

As an alternative embodiment, a display of the set of instructions can permanently appear, in a secondary window, next to the navigation map.

According to another alternative embodiment, the instructions can be provided in the form of an audible message.

The embodiments thus allow an optimized display to be generated for visualizing the trajectory to be taken, without requiring any additional action, the trajectories requiring specific maneuvers to be carried out, and the impossible trajectories.

In an alternative embodiment, only the instructions can be transmitted on completion of the aforementioned steps 100, 200 and 300. According to another alternative embodiment, the candidate zones and trajectories can be displayed as a function of their classification, without any particular instructions being added, with the operator being able to determine the actions to be implemented by virtue of their expertise.

Various trajectory appearance parameters can be used to distinguish the classifications of the candidate trajectories. The appearance parameters can be color parameters, for example. For a black and white or greyscale human-machine interface, the appearance features can correspond to different line thicknesses, or even to different patterns.

For each candidate trajectory, the coordinates of the points separated by a predefined distance can be computed in the aforementioned reference frame (cf. FIG. 4), so as to establish a sample of the candidate trajectory.

The coordinates can be expressed in the geodetic system of the map, for example, the WGS84 geodetic system, which is notably used by the GPS satellite positioning system. Any other geodetic system also can be suitable.

Each candidate trajectory is thus formed by a set of equidistant points (for example, points 27 in FIG. 4). The distance between each point can vary as a function of the length of the candidate trajectory, or even can be fixed, irrespective of the length of the candidate trajectory.

Computing based on a limited number of points, due to the sample, and on an easily modelled trajectory (an arc of a circle), allows the computational complexity of the guidance method to be reduced, making it compatible with real-time applications.

For each point, from the first point of the candidate trajectory, a first trajectory appearance parameter can be assigned to the candidate trajectory if the estimated depth of the underwater device is less than the sum of the marginal minimum depth of the zone and of the vertical protective margin of the underwater device. The first trajectory appearance parameter then also must be assigned to the preceding point.

A second trajectory appearance parameter can be assigned if, for at least one point of the candidate trajectory, the corrected estimated depth of the underwater device is less than the sum of the marginal minimum depth and of the vertical protective margin of the underwater device.

The corrected estimated depth of the underwater device 11 is computed as a function of the reeled-out length of the tow cable 14, of the speed of the surface vessel 10, of the gyration rate corresponding to the candidate trajectory (24, 25, 26) on which the point is located, and of the one or more predefined actions on said candidate trajectory.

The second trajectory appearance parameter is also assigned to the following points of the candidate trajectory. Thus, points of a candidate trajectory cannot have a first trajectory appearance parameter, if the preceding points, namely those located as close as possible to the surface vessel 10, have a second trajectory appearance parameter.

Thus, according to embodiments of the invention, a candidate trajectory has a first appearance parameter if the first appearance parameter is assigned to all the points of the candidate trajectory, and a candidate trajectory has a second appearance parameter if the second appearance parameter is assigned to at least one point of the candidate trajectory.

A third trajectory appearance parameter can be assigned to the candidate trajectory if the gyration of the candidate trajectory is impossible taking into account the length of the tow cable 14, or if the gyration is impossible taking into account the speed of the surface vessel 10, which corresponds to an excessively small gyration radius.

FIG. 4 shows, for example, a classification of the trajectories according to three appearance levels. With respect to trajectories 25, 26 and 27, for example, it can be seen that a corrective action must be carried out, if the surface vessel is committed to one of these trajectories, in order to avoid damaging the underwater device 11.

It also can note that the trajectory 30 is impossible.

With respect to the other trajectories, for example, the trajectory 24, the surface vessel 10 can be committed to this trajectory without any risk of damaging the underwater device 11.

Steps 100, 200, 300 and 400 of the method can be implemented dynamically or periodically, so as to regularly refresh the guidance assistance, taking into account the change in position of the surface vessel 10, as well as the possible change of the current depth of the underwater device 11.

According to another advantageous embodiment, the positioning of the surface vessel 10 on one of the points of the candidate trajectory can be processed by a computer simulation, in order to anticipate the possible actions to be implemented.

With reference to the example of FIG. 4, such a simulation can make it possible, for example, to identify whether the candidate trajectory 24 retains the first trajectory appearance parameter, or even if another trajectory appearance parameter is assigned thereto, after the last point of the current candidate trajectory 24.

The simulation of the positioning of the surface vessel 10 on one of the points of the candidate trajectory can be carried out, for example, in response to a “click and drag” movement on the graphical interface of the point representing the surface vessel 10 on one of the points of the candidate trajectory, or more generally in response to a pointing action on the graphical interface adapted to the selection of one of the points.

The positioning on future points of a candidate trajectory, as well as the candidate trajectories and/or corresponding actions, can be displayed in a sub-portion of the human-machine interface, for example, in the form of a thumbnail.

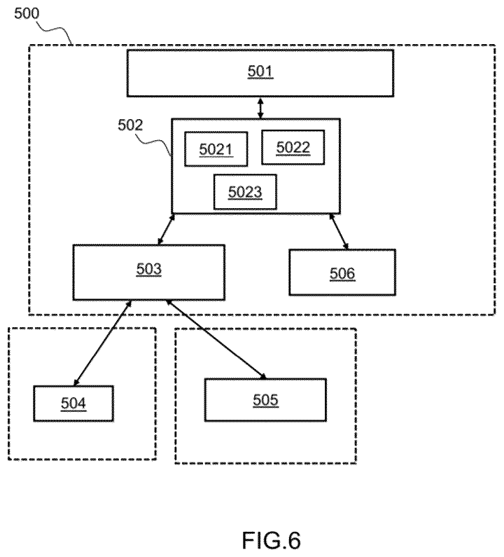

FIG. 6 illustrates the guidance assistance system 500 according to embodiments of the invention.

The guidance assistance system 500 can comprise a human-machine interface 501, in the form of a console and a pointing device configured to allow pointing on the graphical interface. The Human Machine Interface (HMI) 501 is configured to generate a display of an enhanced map, and to receive data from the user (operator), such as the vertical margins, the radius used in the dual bathymetry and/or the candidate trajectories. The guidance assistance system 500 is configured to generate a display of the zones and of the candidate trajectories as a function of their classification and/or to transmit the instructions relating to said actions.

The guidance assistance system 500 comprises a computation device 502 connected to the human-machine interface 501.

The computation device 502 comprises a discretization unit 5021 configured to discretize the geographical sector around the surface vessel into a plurality of zones, a first computation unit 5022 configured to compute the set of candidate trajectories of the surface vessel in the geographical sector, and a classification unit 5023 configured to classify each candidate trajectory as a function of the degree of accessibility of the zone of the geographical sector traversed by the possible trajectory, and as a function of the feasibility of one or more predefined actions on said candidate trajectory.

The computation device 502 can receive or determine navigation parameters of the surface vessel, and/or parameters relating to the winch representing the length of the unwound cable 14. Such parameters can be extracted by an immersion assistance service server 503.

In the event that it is detected that actions are to be implemented in order to avoid damage to the underwater device 11, the computation device 502 can transmit corresponding commands to the immersion assistance service server 503.

The immersion assistance service server 503 can be connected either to a simulator 504 when the guidance assistance device 500 is used for simulation, or to a navigation parameter determination unit 505 on board the surface vessel 10 in order to determine the navigation parameters.

The computation device 502 also can be connected to a map server 506 that provides bathymetry data.

1. A method for assisting the guidance of a surface vessel intended to tow an underwater device by means of a tow cable, the method comprising:
a) discretizing the geographical sector around the surface vessel into a plurality of zones, with each zone being classified according to a degree of accessibility from among a set of degrees of accessibility, as a function of the bathymetry of the geographical sector and of current navigation parameters of the surface vessel comprising the length of the tow cable;
b) computing a set of candidate trajectories of the surface vessel in said geographical sector, with each candidate trajectory corresponding to a different gyration rate from the current position of the surface vessel;
c) classifying each candidate trajectory as a function of the degree of accessibility of the zone of the geographical sector traversed by the possible trajectory, and as a function of the feasibility of one or more predefined actions on said candidate trajectory;
d) generating a display of the zones and of the candidate trajectories on a human-machine interface, as a function of their classification and/or a transmission of instructions relating to said actions.

2. The method as claimed in claim 1, wherein each zone has a marginal minimum depth, with said marginal minimum depth of each zone being computed based on the minimum depth of all the zones located within a predefined radius around said zone, and the underwater device has a current depth and wherein the set of degrees of accessibility comprises:
a first degree of accessibility if the marginal minimum depth of the zone is greater than or equal to the sum between a vertical protective margin of the underwater device and the current depth of the underwater device, with said current depth of the underwater device being computed as a function of the reeled-out length of the tow cable and of the speed of the surface vessel;
a second degree of accessibility if the marginal minimum depth of the zone is strictly less than said sum between the vertical protective margin of the underwater device and the current depth of the underwater device, and if the marginal minimum depth of the zone is greater than or equal to the protective margin of the underwater device;
a third degree of accessibility if the marginal minimum depth of the zone is strictly less than the vertical protective margin of the underwater device.

3. The method as claimed in claim 2, wherein a first zone appearance parameter, a second zone appearance parameter, and a third zone appearance parameter are respectively assigned to the first degree of accessibility, to the second degree of accessibility, and to the third degree of accessibility.

4. The method as claimed in claim 3, wherein the first zone appearance parameter, the second zone appearance parameter, and the third zone appearance parameter correspond to different colors.

5. The method as claimed in claim 2, wherein each candidate trajectory is sampled at a plurality of equidistant points, and wherein the following is assigned to each point, from the first point of the candidate trajectory:
a first trajectory appearance parameter if said first trajectory appearance parameter has been assigned to the previous point and if the estimated depth of the underwater device is less than the sum of the marginal minimum depth of the zone and of the vertical protective margin of the underwater device, with the estimated depth of the underwater device being computed as a function of the reeled-out length of the tow cable, of the speed of the surface vessel and of the gyration rate corresponding to the candidate trajectory on which the point is located;
a second trajectory appearance parameter if the corrected estimated depth of the underwater device is less than the sum of the marginal minimum depth and of the vertical protective margin of the underwater device, with the corrected estimated depth of the underwater device being computed as a function of the reeled-out length of the tow cable, of the speed of the surface vessel, of the gyration rate corresponding to the candidate trajectory on which the point is located, and of one or more predefined actions on said candidate trajectory,
with the second trajectory appearance parameter also being assigned to the following points of the candidate trajectory;
a third trajectory appearance parameter if the gyration of the candidate trajectory is impossible taking into account the length of the tow cable, or if the gyration is impossible taking into account the speed of the surface vessel,
with the third trajectory appearance parameter also being assigned to the following points of the candidate trajectory.

6. The method as claimed in claim 5, wherein the first trajectory appearance parameter, the second trajectory appearance parameter, and the third trajectory appearance parameter correspond to different colors.

7. The method as claimed in claim 2, further comprising a step of correcting the vertical protective margin of the underwater device, and/or a step of correcting the predefined radius used when computing the marginal minimum depth.

8. The method as claimed in claim 1, wherein said predefined actions include an action of raising the underwater device and/or an action of accelerating the surface vessel.

9. The method as claimed in claim 1, wherein the feasibility of one or more predefined actions on said candidate trajectory is computed taking into account the time for carrying out the action prior to the arrival of the surface vessel in a zone classified according to a degree of accessibility different from the zone corresponding to the current position of the surface vessel.

10. The method as claimed in claim 1, wherein the step of generating a display of each possible trajectory comprises generating a display of the trajectory in the form of an arc of a circle passing through a point representing the surface vessel, or in the form of a segment aligned with the point representing the heading of the surface vessel.

11. The method as claimed in claim 1, wherein steps a) to d) are repeated periodically.

12. The method as claimed in claim 1, comprising, in response to the user selecting one of the points located on the representation of one of the candidate trajectories generated on the human-machine interface, a step of simulating steps a) to d), while considering that the surface vessel is fictitiously positioned at said point.

13. A computer program product, comprising instructions for executing the method as claimed in claim 1 when the program is executed by a processor.

14. A system for assisting the guidance of a surface vessel intended to tow an underwater device by means of a tow cable, the system comprising:
a computation device comprising:
a discretization unit, configured to discretize the geographical sector around the surface vessel into a plurality of zones, with each zone being classified according to a degree of accessibility from among a set of degrees of accessibility, as a function of current navigation parameters of the surface vessel comprising the length of the tow cable;
a first computation unit, configured to compute a set of candidate trajectories of the surface vessel in said geographical sector, with each candidate trajectory corresponding to a different gyration rate from the current position of the surface vessel;
a classification unit, configured to classify each candidate trajectory as a function of the degree of accessibility of the zone of the geographical sector traversed by the possible trajectory, and as a function of the feasibility of one or more predefined actions on said candidate trajectory;
a human-machine interface configured to generate a display of the zones and of the candidate trajectories as a function of their classification and/or to transmit the instructions relating to said actions.

15. The system as claimed in claim 14, wherein the underwater device comprises a sonar.
